(19) United States
(12) Patent Application Publication
(10) Pub. No.: US 2011/0244991 A1
(43) Pub. Date: Oct. 6, 2011

(54) GOLF ASSISTING DEVICE AND METHOD OF AUTOMATICALLY SWITCHING TARGET GOLF HOLES

(75) Inventor: YUEH-LING LIN, Jhubei City (TW)

(73) Assignee: GTA ELECTRONICS CO., LTD., TAIPEI (TW)

(21) Appl. No.: 12/752,300

(22) Filed: Apr. 1, 2010

(51) Int. Cl. A63B 57/00; G06F 19/00

(52) U.S. Cl. 473/407; 473/409; 700/91

(57) ABSTRACT

A method of automatically switch of target golf hole is applied in a golf assisting device. The golf assisting device utilizes the memory to store a plurality of golf-hole-region coordinates that define a plurality of regions belonged to every golf hole. A processor of the golf assisting device is used to determine which convex polygon region the golf assisting device is located in accordance with the stored golf-hole-region coordinates in order to automatically switch a corresponding target golf hole of the convex polygon region. The golf assisting device determines in accordance with the corresponding target golf hole of the convex polygon region to proceed and operate other various functions of the golf assisting device so that the golf assisting device can be operated and switched automatically without any manual operation from the golfer.

### FIELD OF THE INVENTION

The present invention relates to, and more particularly to a golf assisting device and its method thereof, more particularly, related to a golf assisting device that can automatically switch the target golf holes number without manual operation.

### BACKGROUND OF THE INVENTION

Golf is a sport requires precision control in order for a golfer to aim and strike the ball into a target hole. In order to strike accurately to the direction in which the target lies and the direction you intend your ball to go, various of golf assisting equipments have been invented, such as GPS golf assisting device has been developed to record all the holes or locate particular target in the golf course field. The GPS technology can provide accurate position coordinate of a specific target and determine the distance between the specific target and the golfer.

The golf assisting device can further incorporate with the detecting device to detect the wind direction and speed so that the weather conditions that can affect the trajectory of the golf ball travel and spin can be provide to the golfer for more effective strikes.

However, the current conventional golf assisting devices function mostly manually by the golfer to determine and provide the information of the target golf hole when the golfer changes his/her position from one hole to another one. In other words, the conventional golf assisting device cannot determine automatically on its own, it has to be inputted manually the information of the position of the next target golf hole to be able to provide the necessary information to the player. The manual operation is inconvenient to the player, and it induces extra operation procedures for the player. Further, when the player chooses wrong golf hole, the inaccurate information will be provided to the player instead of the correction data.

### SUMMARY OF THE INVENTION

In view of the foregoing shortcomings of the conventional designs, the present invention provides an improved golf assisting device that can function automatically to switch from one target golf hole to another one without manually operations. The player or golfer does not require to input or select the correct target golf hole as the golf assisting device of the present invention can determine the correct target golf hole from the position of the golf assisting device.

These features and advantages of the present invention will become more fully apparent from the following description and appended claims, or may be learned by the practice of the invention as set forth thereinafter.

The method of the present invention of automatically switching from a target golf hole to another, applied in a golf assisting device, comprising:
(1) pre-storing a plurality of golf-hole-region coordinates to define a plurality of regions belonged to every golf hole, wherein at least one convex polygon region is formed in accordance with the golf-hole-region coordinates of every golf hole;
(2) proceeding a GPS search to determine a position coordinate of the golf assisting device;
(3) defining a convex polygon region that the golf assisting device is belonged to in accordance with the determined position coordinate of the golf assisting device;
(4) switching automatically to a corresponding target golf hole in accordance with the convex polygon region of the golf assisting device; and
(5) outputting the corresponding target golf hole.

One of preferred embodiment of the present invention, the method of automatically switching from one target golf hole to another, wherein the step (3) further comprises either outputting a previous target golf hole and its striking information, or stopping to output any target golf hole information and return to step (2), when the golf assisting device is entered into a plurality of convex polygon regions.

In another preferred embodiment of the present invention, the determination of step (3) comprises adding all inner angles intersected from the determined position coordinate of the golf assisting device to every vertex of a convex polygon region, when a total amount of the angles is 360 degrees, it indicates that the position of the golf assisting device is in the convex polygon region.

The step (3) of determine process also can be operated when a straight lined is drawn from the position coordinate of the golf assisting device, in which the straight line intersects two points of the convex polygon region, and the position coordinate of the golf assisting device will be positioned between the two points of intersection of the convex polygon region to indicate that the position of the golf assisting device is corresponding to the convex polygon region.

In order to achieve the above-mentioned objectives, the present invention provides a golf assisting device for automatically switching target golf holes, capable of providing all striking information for a target golf hole, comprising:
a GPS module, for receiving GPS signals;
a memory, for storing a plurality of golf-hole-region coordinates for defining a plurality of regions belonged to every golf hole, wherein at least one convex polygon region is formed in accordance with the golf-hole-region coordinates of every golf hole;
a processor, for calculating a position coordinate of the golf assisting device in according to a received GPS signal, wherein the processor is electrically connected to the GPS module and the memory to determine whether the golf assisting device is located within the convex polygon regions in accordance with the golf-hole-region coordinates stored in the memory in order to automatically switch a corresponding target golf hole of the convex polygon region; and
a display device, for displaying the corresponding target golf hole information, and electrically connected to the processor.

The golf assisting device for automatically switching target golf holes in accordance with another preferred embodiment of the present invention, comprising:
a GPS module, for receiving GPS signals;
a memory, for storing a plurality of golf-hole-region coordinates to define a plurality of regions belonged to every golf hole, wherein at least one convex polygon region is formed in accordance with the golf-hole-region coordinates of every golf hole;
a processor, for calculating a position coordinate of the golf assisting device in according to a received GPS signal, wherein the processor is electrically connected to the GPS module and the memory to determine whether the golf assisting device is located within the convex polygon regions in accordance with the golf-hole-region coordinates stored in the memory in order to automatically switch a corresponding target golf hole of the convex polygon region, wherein the processor outputs a previous target golf hole or stop to output any target golf hole information when the golf assisting device is entered to a plurality of convex polygon regions; and
a display device, for displaying the target golf hole information, and electrically connected to the processor.

The golf assisting device of the present invention first to store all the golf-hole-region coordinates corresponding to each golf hole in order to define the convex polygon regions of each golf hole. When the golfer enters into one of the convex polygon regions, the target golf hole of the golf assisting device will be determined in accordance with the corresponding golf hole of the convex polygon region in order to proceed and operate other various functions of the golf assisting device so that the golf assisting device can be operated and switched automatically without any manual operation from the golfer.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that theses drawings depict only typical embodiments of the invention and are not therefore to be considered to be limiting of its scope, the invention will be described and explained with additional specificity and detail through the use of the accompanying drawings, in which:

FIG. 1 is a partial schematic view of a golf field in which a golf hole TP1 is indicated;

FIG. 2 is a schematic block chart showing how the automatic switching function of the golf assisting device in accordance with one of preferred embodiments of the present invention is operated;

FIG. 3A is a perspective view of a determined protruding region;

FIG. 3B is a perspective view of a determined protruding region;

FIG. 4 is a partial schematic view of a golf filed with two golf holes, TP1 and TP2, are showed;

FIG. 5 is schematic flow chart of a method of automatically switching target golf holes in accordance with one preferred embodiment of the present invention; and

FIG. 6 is a schematic view of a method of automatically switching target golf holes in accordance with another preferred embodiment of the present invention.

### DETAILED DESCRIPTION OF THE PREFERRED EMBODIMENTS

For the purpose of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

When a GPS is applied in the field of golf, one of its main functions is to provide the accurate data of the distance between a golfer and his target hole in order for the golfer to choose the right club. Many of the assisting tools are capable of detecting the wind direction and wind speed to provide more detail information to the golfer so that the golfer can determine the striking force and the direction in accordance with the information. The golf assisting device of the present invention is capable of automatically switch between the target holes in such that once the golfer stands within a range of a particular target golf hole, the golf assisting device will automatically switch to that particular golf hole accurately to determine the required information of the striking without manually operated by the player.

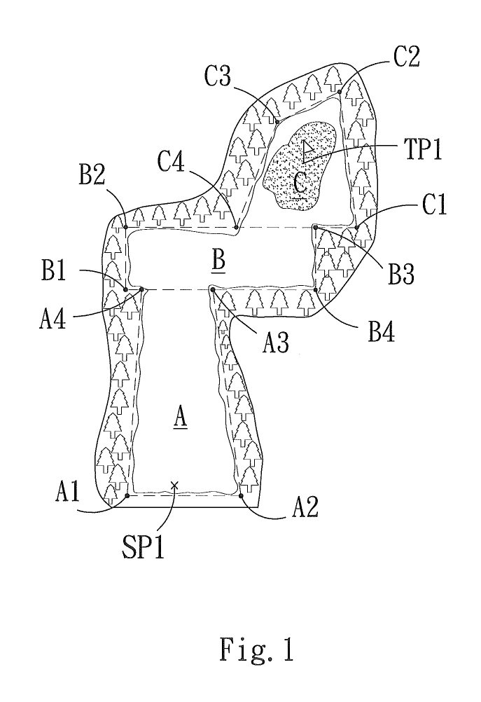

Refer to FIG. 1, a partial schematic golf field is shown, wherein a target golf hole TP1 is indicated. The region around the target golf hole TP1 is predetermined. The region of the target golf hole TP1 is defined in accordance with all the possible paths of the golfer may pass during golfing in respect with the target golf hole. The purpose of defining the region of the target golf hole TP1 is to determine a corresponding region that is corresponding to the target golf hole TP1. The region is divided into regions A, B and C of the target golf hole TP1 as shown in FIG. 1. Once the golfer enters one of the three regions with the golf assisting device, the target golf hole TP1 will be set as the analysis target by the golf assisting device to illustrate all the striking information for the golfer.

Each region of regions A, B and C of FIG. 1 is a convex polygon region, which comprises several vertices and has a total inner angle of 360 degrees, that is, any inner point of the convex polygon region intersected to all the vertices of the convex polygon region will form several inner angles in respect with that inner point, and a total amount of these inner angles will be 360 degrees. However, the multiple regions of the regions A, B and C as shown in FIG. 1 is one of preferred examples. Each convex polygon region is defined through a plurality of golf-hole-region coordinates. For the convex polygon region A, the golf-hole-region coordinates of the region A are A1 to A4 which are pre-inputted into the golf assisting device so that those four points of the golf-hole-region coordinates are connected and formed the boundaries of the convex polygon region A. The corresponding golf hole of region A is then selected golf hole TP1. The golf assisting device of the present invention utilizes the convex polygon to define every region belonged to a golf hole so that every region can be easily define without complex calculation to increase the effectiveness of the golf assisting device.

From FIG. 1, when the golfer starts from an initiate point SP1, the regions A, B and C comprise all the possible striking points around the golf field, in other words, the golf assisting device determines all the possible striking points in respect with the TP1 within the regions A, B and C. No matter where the golfer starts around the regions, the golf assisting device can analysis and determine accurately with respect to the target golf hole TP1 all the necessary information to the golfer.

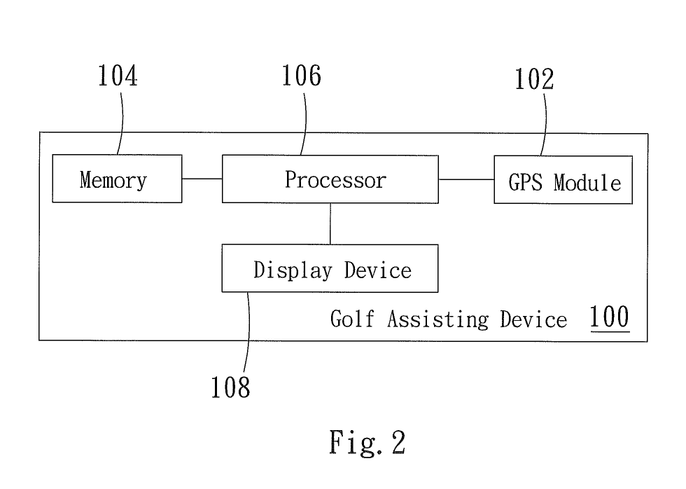

FIG. 2 shows a block chart of automatic switching golf hole function of the golf assisting device in accordance with one of preferred embodiments of the present invention. The golf assisting device 100 of the present invention comprises a GPS module 102, a memory 104, a processor 106 and a display device 108. The GPS module 102 is electrically connected to the processor 106 and is utilized to receive GPS signals. The memory 104 is used to store a plurality of golf-hole-region coordinates of the defined regions belonged to every golf hole, such as the coordinates A1 to A4 of region A of the golf hole TP1, coordinates B1 to B4 of region B of the golf hole TP1, coordinates C1 to C4 of region C of the golf hole TP1 and coordinates D1 to D4 of region D of the golf hole TP1. The golf-hole-region coordinates of the regions of every golf hole will be generated to at least one convex polygon region as shown in the regions A, B and C of convex polygon in FIG. 1.

The processor 106 calculates the coordinate of the current position of the golf assisting device 100 in accordance with the received GPS signal from the GPS module 102. The calculated coordinate of the golf assisting device 100 is then used to determine which of the convex polygon regions is the golf assisting device 100 belonged to by using the golf-hole-region coordinates of the golf hole stored in the memory 104 in order to automatically switch a corresponding target golf hole of corresponding convex polygon region.

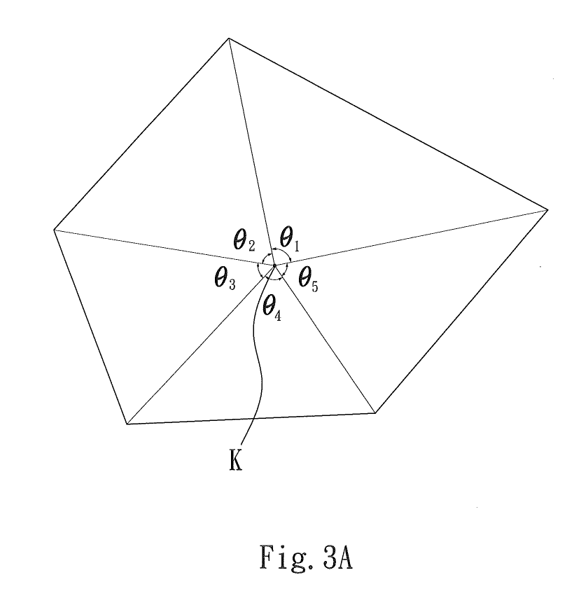

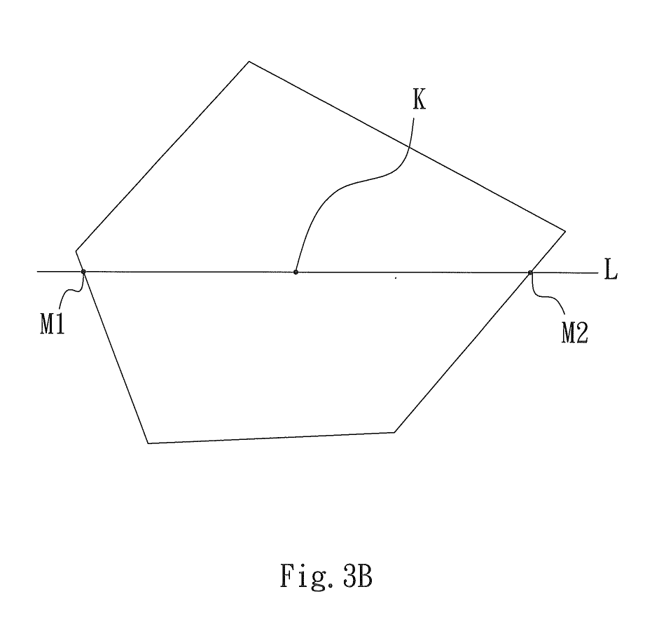

One method of determination in accordance with one preferred embodiment of the present invention, any inner point of the convex polygon region intersected to all the vertices of the convex polygon region will form several inner angles in respect with that inner point, and a total amount of these inner angles will be 360 degrees. FIG. 3A shows that the angles generated from point K to every vertex will not be overlapped and the total of the inner angles is 360 degrees. Therefore, when the above-mentioned condition is fulfilled, then the golf assisting device is located within the specific convex polygon region.

Another method of determination in accordance with another preferred embodiment of the present invention, any point inner the convex polygon region is formed a straight line, this straight line is intercrossed with two points on boundary of the convex polygon, and the point can be anywhere between this boundary points as shown in FIG. 3B. The position of K can be any point on the straight line L, wherein the straight line L is drawn from K to intersect two points M1 and M2 on the convex polygon, that is, when the position of K is on the line L between the points M1 and M2, then the position of K is within the convex polygon region. Therefore, when the coordinate fulfills the condition, then it indicates that the golf assisting device 100 is within the specific convex polygon region.

The above-mentioned methods are used to determine the position of the golf assisting device, when the coordinate of the golf assisting device is just on the boundary of a convex polygon, it indicates that the golf assisting device is within the specific convex polygon region.

However, the methods illustrated in the embodiments are used merely as example to explain the operation of the golf assisting device, the golf assisting device is not intend to restrict or limit to one specific method of determination.

The memory 104 stores the golf-hole-region coordinates that are corresponding to every convex polygon region. The processor 106 calculates the current coordinate and then determines whether it is within the convex polygon region. If the coordinate falls within the convex polygon region, the golf hole will be determined to a target golf hole. Vice versa, when the coordinate falls outside all the convex polygon regions, no data of the target golf hole is displayed to prevent any mistaken information from displaying. Once the corresponding target golf hole is determined, the golf assisting device 100 will proceed various of calculation and analysis for the striking or striking information to provide to the golfer for reference or instruction. The display device 108 is electrically connected to the processor 106 for display the determined target golf hole and its striking information of the particular target golf hole.

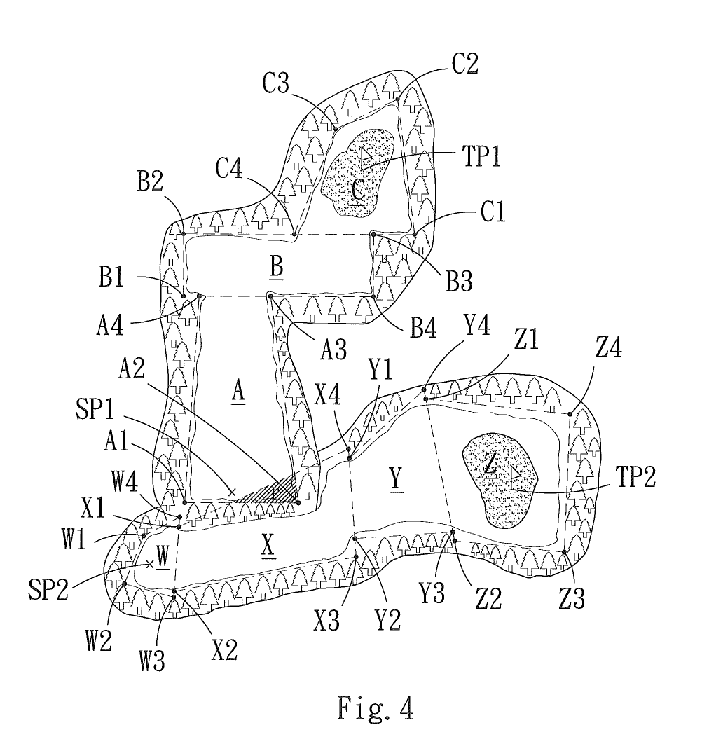

Refer to FIG. 4, a partial schematic golf field is shown, wherein golf holes TP1 and TP2 is indicated. The regions around the golf holes TP1 and TP2 are predefined. Regions W, X, Y and Z are defined as the regions of golf hole TP2. The start point SP2 is located within the region W, wherein the a plurality of golf-hole-region coordinates of the golf hole TP2, W1 to W4, X1 to X4, Y1 to Y4 and Z1 to Z4 are corresponding to regions W, X, Y and Z, respectively. Those regions are described as above to form a convex polygon region.

The regions of the golf field could be possibly overlapped with each other. FIG. 4 shows that an overlapped regions P which are corresponding to two golf holes, TP1 and TP2. When the golf assisting device appears in region P, the processor 106 will output a previous target golf hole or stop output any target golf hole coordinate. For example, when golfer starts from region A, and then enters into region P, the target golf hole which the processor 106 calculates first is TP1, then when the golf assisting device enters region P, the target golf hole which is calculated by the processor 106 will result in two holes of TP1 and TP2, in such a case, the processor 106 will output the previous target golf hole, which is TP1, instead of TP1 and TP2. Vice versa, when the golf assisting device 100 appears in region P first, the target golf hole which the processor 106 calculates will be both target golf holes TP1 and TP2, but since there is not previous corresponding target golf hole data, the processor 106 will not output or display any information of the target golf hole to prevent any mistaken information from showing.

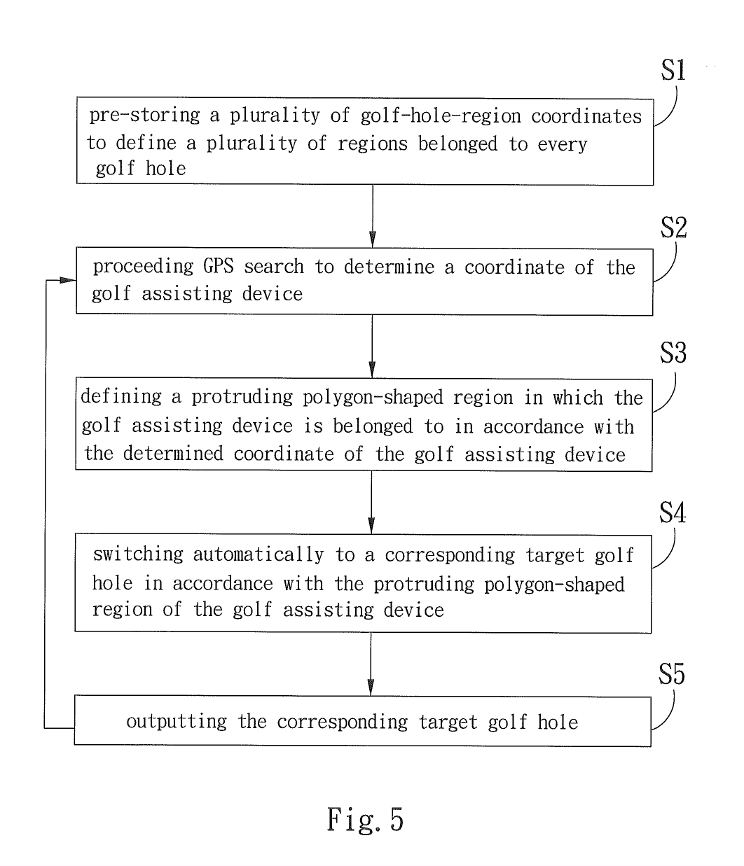

FIG. 5 illustrates a flow chart of the method of automatically switch function of the golf assisting device:

(S1) pre-storing a plurality of golf-hole-region coordinates to define a plurality of regions belonged to every golf hole;
(S2) proceeding GPS search to determine a coordinate of the golf assisting device;
(S3) defining a convex polygon region in which the golf assisting device is belonged in accordance with the determined coordinate of the golf assisting device;
(S4) switching automatically to a corresponding target golf hole in accordance with the convex polygon region of the golf assisting device;
(S5) outputting the corresponding target golf hole, and proceeding to step (S2) when the golfer changes his/her target golf hole, the golf assisting device can provide and display all the necessary striking information of the target golf hole.

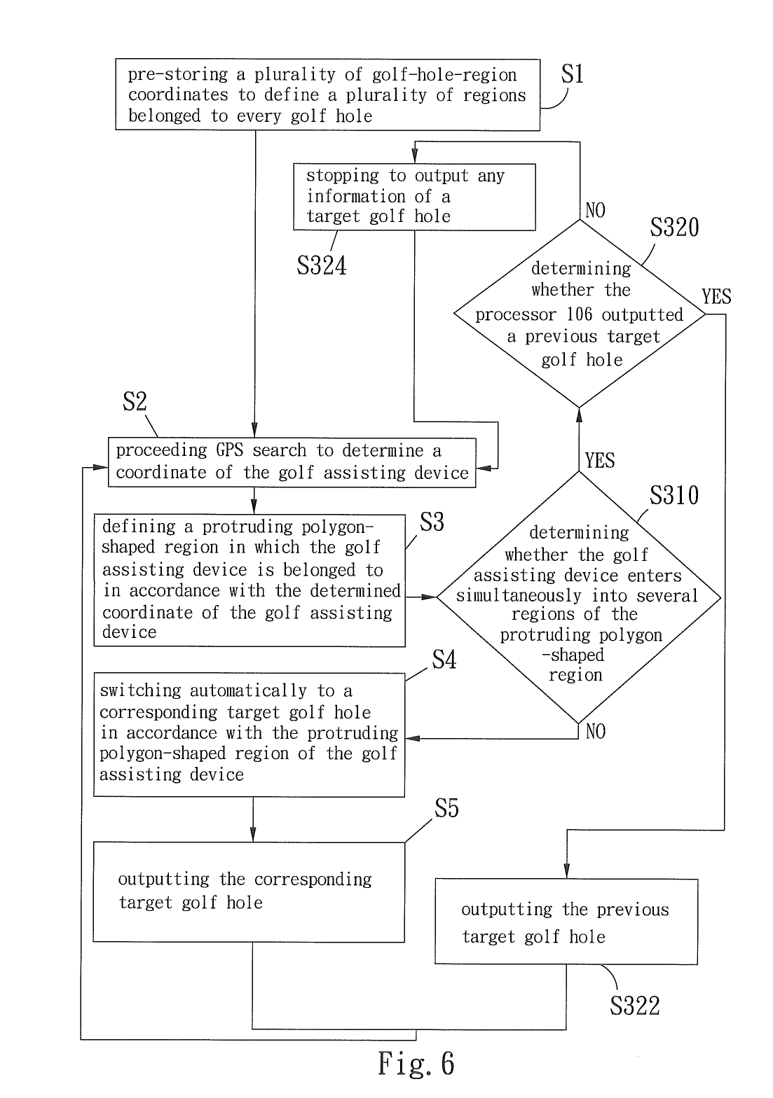

As shown in FIG. 6, step (S3) further comprises a step of either outputting a previous target golf hole and its striking information in respect with the previous target golf hole, or stopping to output any information when the golf assisting device is entered into a plurality regions of the convex polygon region. Step (S310): determining whether the golf assisting device enters simultaneously into several regions of the convex polygon region, if yes, the system will proceed to step (S320), if not, the system will proceed to step (S4). Step (S320): determining whether the processor 106 outputted a previous target golf hole, if yes, the system proceeds to step (S322), if not, the system proceeds to Step (S324). Step (S322): outputting a previous target golf hole; step (324): stopping to output any information of a target golf hole, wherein the system will return to step (S2). Step (S5) and step (S322) will return to step (S2) when the golfer changes his striking position.

The golf assisting device of the present invention first to store all the golf-hole-region coordinates corresponding to every golf hole in order to define a plurality of regions belonging to every golf hole. When the golfer enters into one of convex polygon regions of a particular golf hole, a target golf hole of the golf assisting device will be determined in accordance with the golf hole of the convex polygon region in order to proceed and operate other various functions of the golf assisting device so that the golf assisting device can be operated and switched automatically without any manual operation from the golfer.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method of automatically switching of a target golf hole, applied in a golf assisting device, comprising:
(1) pre-storing a plurality of golf-hole-region coordinates to define a plurality of regions belonged to every golf hole, wherein at least one convex polygon region is formed in accordance with the golf-hole-region coordinates of every golf hole;
(2) proceeding a GPS search to determine a position coordinate of the golf assisting device;
(3) defining a convex polygon region in which the golf assisting device is belonged to in accordance with the determined position coordinate of the golf assisting device;
(4) switching automatically to a corresponding target golf hole in accordance with the convex polygon region of the golf assisting device; and
(5) outputting the corresponding target golf hole.

2. The method of claim 1, wherein step (3) comprises either outputting a previous target golf hole and its striking information, or stopping to output any target golf hole information and return to step (2), when the golf assisting device is entered into a plurality of convex polygon regions.

3. The method of claim 1, wherein the determination of step (3) is to add all inner angles intersected from all vertices of the convex polygon region with the determined position coordinate, and a total amount of these inner angles is 360 degrees, it indicates that the position of the golf assisting device is in the convex polygon region.

4. The method of claim 1, wherein step 3 further comprises that when a straight lined is drawn from the position coordinate of the golf assisting device, in which the straight line intersects two points of the convex polygon region, and the position coordinate of the golf assisting device will be positioned between the two points of intersection of the convex polygon region to indicate that the position of the golf assisting device is corresponding to the convex polygon region.

5. A golf assisting device for automatically switching target golf hole, capable of providing all striking information for a target golf hole, comprising:
a GPS module, for receiving GPS signals;
a memory, for storing a plurality of golf-hole-region coordinates for defining a plurality of regions belonged to every golf hole, wherein at least one convex polygon region is formed in accordance with the golf-hole-region coordinates of every golf hole;
a processor, for calculating a position coordinate of the golf assisting device in according to a received GPS signal, wherein the processor is electrically connected to the GPS module and the memory to determine whether the golf assisting device is located within the convex polygon regions in accordance with the golf-hole-region coordinates stored in the memory in order to automatically switch a corresponding target golf hole of the convex polygon region; and
a display device, for displaying the corresponding target golf hole information, and electrically connected to the processor.

6. A golf assisting device for automatically switching target golf hole, capable of providing all striking information for a target golf hole, comprising:
a GPS module, for receiving GPS signals;
a memory, for storing a plurality of golf-hole-region coordinates to define a plurality of regions belonged to every golf hole, wherein at least one convex polygon region is formed in accordance with the golf-hole-region coordinates of every golf hole;
a processor, for calculating a position coordinate of the golf assisting device in according to a received GPS signal, wherein the processor is electrically connected to the GPS module and the memory to determine whether the golf assisting device is located within the convex polygon regions in accordance with the golf-hole-region coordinates stored in the memory in order to automatically switch a corresponding target golf hole of the convex polygon region, wherein the processor outputs a previous target golf hole or stop to output any target golf hole information when the golf assisting device is entered to a plurality of convex polygon regions; and
a display device, for displaying the target golf hole information, and electrically connected to the processor.
